(19) United States
(12) Patent Application Publication
(10) Pub. No.: US 2021/0362625 A1
(43) Pub. Date: Nov. 25, 2021

(54) METHOD FOR ADJUSTING A SEAT COMPONENT OF A MOTOR VEHICLE SEAT, AND MOTOR VEHICLE SEAT

(71) Applicant: Faurecia Autositze GmbH, Stadthagen (DE)

(72) Inventors: Felix Golly, Hannover (DE); Claudiu Ionescu, Niedernwöhren (DE)

(73) Assignee: Faurecia Autositze GmbH, Stadthagen (DE)

(21) Appl. No.: 17/328,575

(22) Filed: May 24, 2021

(30) Foreign Application Priority Data
May 25, 2020 (DE) 10 2020 113 982.9

(51) Int. Cl. B60N 2/02

(52) U.S. Cl. CPC B60N 2/0244; B60N 2002/0236; B60N 2002/0272; B60N 2/0232

(57) ABSTRACT

In a method for adjusting a seat component of a motor vehicle seat, a manual adjustment of a seat component is detected which manual adjustment can be adjusted by a motor. A force is generated by activating the motor to adjust the seat component in response to the manual adjustment.

### CROSS-REFERENCES TO RELATED APPLICATIONS

This application claims the priority of German Patent Application, Serial No. DE 10 2020 113 982.9, filed May 25, 2020, pursuant to 35 U.S.C. 119(a)-(d), the disclosure of which is incorporated herein by reference in its entirety as if fully set forth herein.

### BACKGROUND OF THE INVENTION

The present invention relates to a motor vehicle seat and to a method for adjusting a seat component of a motor vehicle seat.

The following discussion of related art is provided to assist the reader in understanding the advantages of the invention, and is not to be construed as an admission that this related art is prior art to this invention.

Modern motor vehicle seats have adjustment devices that are operated by a motor. The adjustment of the backrest inclination and the adjustment of the motor vehicle seat in a longitudinal direction should be mentioned in particular. After an adjustment movement, the motor vehicle seat is latched in the new position. Latching is usually carried out by means of additional snap-in mechanisms.

It would be desirable and advantageous to provide an improved motor vehicle seat and method of adjusting a motor vehicle seat to obviate prior art shortcomings in a simple and inexpensive manner.

### SUMMARY OF THE INVENTION

According to one aspect of the present invention, a method for adjusting a seat component of a motor vehicle seat includes detecting a manual adjustment of a seat component, and generating a force by activating a motor to adjust the seat component in response to the manual adjustment.

A method according to the invention for adjusting a seat component of a motor vehicle seat has two method steps:

In the first method step, a manual adjustment of a seat component that can be adjusted by a motor is detected. The manual adjustment of the seat component causes an adjustment of the seat component from a resting state (desired state).

In the second method step, the motor is activated, which generates a force. In particular, the motor generates a force which counteracts the manual adjustment of the seat component. The deviation from the desired state of the seat component is compensated for by the motor in that the motor exerts a force on the seat component in such a way that the desired state of the seat component is maintained and/or does not exceed a predetermined threshold value.

According to the invention, the motor for the adjustment of the seat component by a motor is advantageously at the same time the motor that is driven in order to hold the seat component in the desired position. The method according to the invention therefore does not require any additional components such as brakes or latching mechanisms, the installation of which is associated with higher costs and increased space requirements.

To ensure clarity, it is necessary to establish the definition of several important terms and expressions that will be used throughout this disclosure.

The term “seat component” is understood to mean a seat component that has a direct influence on the seat position. This comprises the seat cushion (one or more parts as in the case of a seat depth adjustment), side bolsters of the seat cushion, the backrest, side bolsters of the backrest, the backrest head, the headrest and armrests, or the motor vehicle seat as a whole.

The term “adjustment device for adjusting seat components” is understood to mean adjustment devices which change the position and/or the angle of a first seat component to a second seat component or the position and/or the angle of the motor vehicle seat to the floor of the vehicle.

The term “manual adjustment of a seat component” is understood to mean adjustments caused by external forces exerted by a user on a seat component, which adjustments change the position and/or the angle of a first seat component relative to a second seat component or the position and/or the angle of the motor vehicle seat relative to the floor of the vehicle. The manual adjustment also comprises the unlocking of the adjustment device to release a manual adjustment, provided a locking unit is available or If appropriate.

According to another advantageous feature of the invention, the manual adjustment can be detected by a sensor that generates a sensor signal in response to the manual adjustment. The sensor can be designed as any switching element, for example as a Hall sensor, inductive sensor, optical sensor, transistor, and/or field effect transistor. The sensor signal is usually a voltage signal that is proportional to the manual adjustment.

According to another advantageous feature of the invention, a control algorithm can be executed after detecting the manual adjustment of the seat component. The control algorithm evaluates the voltage signal of the sensor for the direction and in particular the strength of the manual force exerted on the seat component.

According to another advantageous feature of the invention, a voltage signal can be generated to cause a rotary movement of the motor after detecting the manual adjustment of the seat component. The voltage signal is usually designed in such a way that the detected speed of the adjustment movement counteracts the manual movement as a differentiation of the path signal.

According to another advantageous feature of the invention, the voltage signal can be proportional to a speed of the manual adjustment. The voltage signal usually uses a pulse-width-modulated voltage of the manual movement of the seat component therefore only the driving force is counteracted by the motor in order to maintain the desired position of the seat component. This reduces the energy requirement of the motor.

According to another advantageous feature of the invention, the force generated by the motor can counteract a movement of the manual adjustment. The deviation from the desired state of the seat component is compensated for by the motor in that the motor exerts a force on the seat component in such a way that the desired state of the seat component is maintained and/or does not exceed a predetermined threshold value. According to the invention, the motor for the adjustment of the seat component by a motor is advantageously at the same time the motor that is driven in order to hold the seat component in the desired position. A method according to the invention therefore does not require any additional components such as brakes or latching mechanisms, the installation of which is associated with higher costs and increased space requirements.

According to another advantageous feature of the invention, the manual adjustment can be detected by a memorization sensor system and/or by a sensor for detecting an actuation of a control element and/or an unlocking means and/or by means of a sensor for detecting an adjustment path. A method according to the invention therefore does not necessarily require a separate sensor arranged in the seat component to be adjusted, but can use sensors or sensor systems installed and arranged in the motor vehicle. Only the control algorithm for triggering the counterforce acting on the seat component to be adjusted needs to be present in the computer system of the motor vehicle and/or the motor vehicle seat.

According to another aspect of the invention, a motor vehicle seat, includes a seat component, and a motorized adjustment device for adjusting seat component, said the motorized adjustment device including a self-locking mechanism configured such that the self-locking mechanism in a first direction of movement of the adjustment device is unequal to the self-locking mechanism in a second direction of movement of the adjustment device.

Self-locking the motorized adjustment device of the seat component is defined in the scope of this document in such a way that the output shaft of the motor does not rotate. The adjustment device can only be driven when it is driven via the drive shaft of the motor. In the scope of this document, the self-locking mechanism is designed in such a way that the seat component cannot be adjusted in the actuating direction even in the case of an increased application of force. However, it is also conceivable that the self-locking mechanism is designed in such a way that an increased application of force in the actuating direction allows for an adjustment of the closure element.

According to another advantageous feature of the invention, the adjustment device can include a non-self-locking gear motor. Self-locking a motor is usually carried out by means of a sufficiently large gear ratio. According to the invention, the adjustment device is designed to be non-self-locking. In the event of a malfunction of the electrical supply to the adjustment device, for example in the event of a voltage drop due to a discharged battery, a user can adjust the seat component manually at any time.

According to another advantageous feature of the invention, the adjustment device can include a reversible gear motor. The direction of rotation of the electric motor can therefore be reversed in order to allow for the adjustment of the seat component in two or more directions by generating a force.

According to another advantageous feature of the invention, the adjustment device can include a self-locking mechanism configured such that the self-locking mechanism in a first direction of movement of the adjustment device is unequal to the self-locking mechanism in a second direction of movement of the adjustment device. The self-locking mechanism is designed in such a way that the seat component cannot be adjusted in the first direction even in the case of an increased application of force. Self-locking in the first direction is only achieved in that the motor exerts a force on the seat component in such a way that the desired state of the seat component is maintained.

According to another advantageous feature of the invention, the adjustment device can include a self-locking mechanism counter to the direction of movement of the manual adjustment. The self-locking mechanism is designed in such a way that the seat component cannot be adjusted in the first direction even in the case of an increased manual application of force. Self-locking counter to the manual application of force is achieved in that the motor exerts a force on the seat component in such a way that the desired state of the seat component is maintained.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1: is a side view of an embodiment of a motor vehicle seat according to the invention in a normal position;

FIG. 2: is a side view of the motor vehicle seat in an easy-entry position, showing a manual exertion of force to adjust the backrest;

FIG. 3: is a side view of the motor vehicle seat, showing that the adjustment motor counteracts the manual adjustment movement; and

FIG. 4: is a flow diagram for adjusting a seat component of a motor vehicle seat, showing that the adjustment motor counteracts the manual adjustment movement.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments may be illustrated by graphic symbols, phantom lines, diagrammatic representations and fragmentary views. In certain instances, details which are not necessary for an understanding of the present invention or which render other details difficult to perceive may have been omitted.

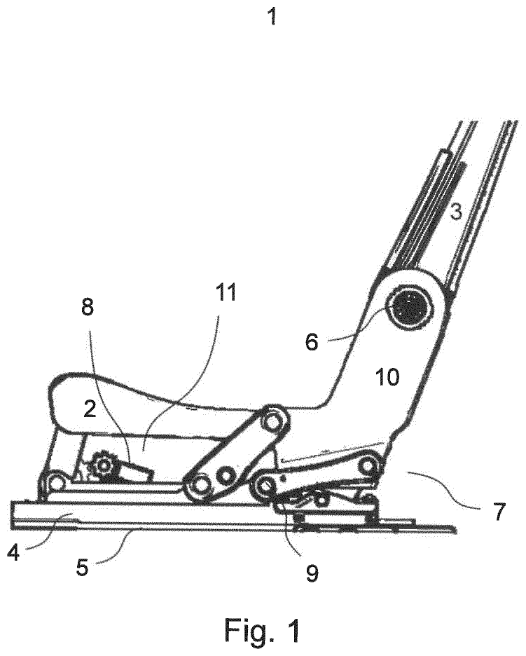

Turning now to the drawing, and in particular to FIG. 1, there is shown a side view of an embodiment of a motor vehicle seat according to the invention, generally designated by reference numeral 1 and assuming a normal position. The motor vehicle seat 1 includes a backrest 3 which can be adjusted. The motor vehicle seat 1 is positioned and locked in the position such that a user can occupy the motor vehicle seat 1. The motor vehicle seat 1 has a seat cushion 2. The backrest 3 is pivotably mounted in a bearing point on a seat frame 10. The backrest 3 can be pivoted by a motor by means of an adjustment motor 8. The motor vehicle seat 1 also has a vertical seat adjustment mechanism 7 and a longitudinal seat adjustment mechanism. The longitudinal seat adjustment mechanism has an upper rail 4 and a lower rail 5. The motor vehicle seat 1 is firmly connected to the upper rail 4, which in turn is guided in the lower rail 5 so as to be adjustable in the longitudinal direction.

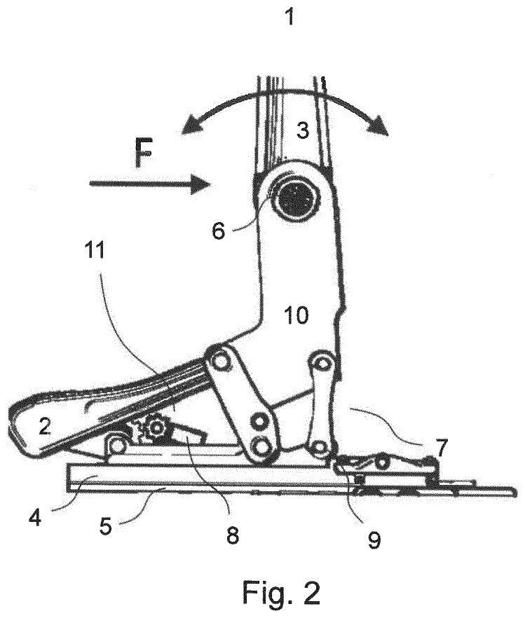

FIG. 2 shows the motor vehicle seat 1 according to the invention in an easy-entry position, for example for a person to enter a rear row of seats of a motor vehicle. The backrest 3 is not latched in its inclination; a user can adjust the backrest 3 manually and by a motor. The motor vehicle seat 1 has a seat cushion 2 and a backrest 3. The motor vehicle seat 1 also has a vertical seat adjustment 7 mechanism and a longitudinal seat adjustment mechanism. The longitudinal seat adjustment mechanism has an upper rail 4 and a lower rail 5. The motor vehicle seat 1 is firmly connected to the upper rail 4, which in turn is guided in the lower rail 5 so as to be adjustable in the longitudinal direction.

The inclination of the backrest 3 can be adjusted by a motor. To adjust the backrest 3, a user usually operates a setting device which initiates the adjustment movement of the backrest 3. The user therefore makes a conscious input in order to adjust the backrest 3.

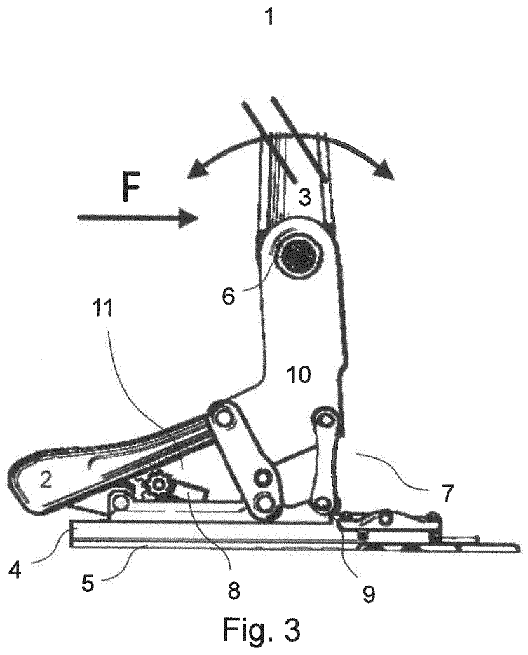

FIG. 3 shows a motor vehicle seat 1 according to experience in an easy-entry position. The backrest 3 is latched in its inclination. The motor vehicle seat 1 has a seat cushion 2 and a backrest 3. The motor vehicle seat 1 also has a vertical seat adjustment 7 mechanism and a longitudinal seat adjustment mechanism. The longitudinal seat adjustment mechanism has an upper rail 4 and a lower rail 5. The motor vehicle seat 1 is firmly connected to the upper rail 4, which in turn is guided in the lower rail 5 so as to be adjustable in the longitudinal direction.

The adjustment device has a sensor 9 and an electric motor 8. In this embodiment, a separate sensor 9 is arranged in the backrest 3, which sensor detects the adjustment path of the backrest 3. The sensor 9 itself is advantageously a commercially available Hall sensor 9, which is inexpensive and resistant to dirt and water.

The sensor 9 can, however, also be part of the sensor system of a memory unit of the motor vehicle seat 1, by means of which the motor vehicle seat 1 can be adjusted by a motor into a position which can be set and which is stored individually for each user. A sensor 9 that detects the actuation of an operating element, i.e., the actuation of the adjustment of the backrest 3 by a motor in this embodiment, is also possible. A sensor 9 which detects the actuation of an unlocking mechanism of the backrest 3 is also conceivable.

The adjustment motor 8 is a non-self-locking electric motor that can adjust the inclination of the backrest 3 via a reduction gear. The electric motor 8 is reversible, i.e., the direction of rotation of the electric motor 8 is reversible in order to drive the adjustment mechanism of the backrest 3 in two directions (forward, backward) by generating a force.

The method for adjusting the backrest 3 detects the manual adjustment of the backrest 3 by a user. In method step 200, the sensor 9 detects this manual adjustment of the backrest 3 and, in the next method step 300, generates a sensor signal proportional to the manual adjustment. A control algorithm determines in method step 400 the direction and the strength of the manual force F exerted on the backrest 3. The voltage signal generated thereupon in method step 500 causes the adjustment motor 8 to perform a rotary movement in method step 600. This rotary movement counteracts in method step 700 the manual adjustment of the backrest 3 carried out by the user. The driving force of the adjustment motor 8 is calculated by the control algorithm 400 in such a way that the desired position (easy-entry position) of the backrest 3 is maintained. The motor vehicle seat 1 according to the invention therefore does not require any additional locking elements in order to hold the motor vehicle seat 1 in the easy-entry position. The backrest 3 of the motor vehicle seat 1 is held in position by the force exerted by the adjustment motor 8.

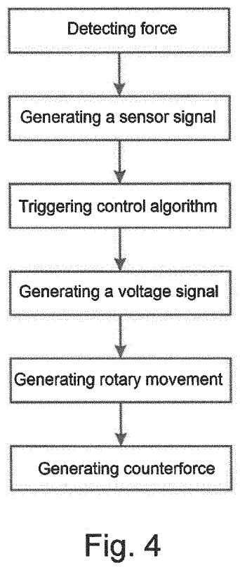

The method according to the invention for adjusting a seat component of a motor vehicle seat 1 is shown in FIG. 4. In this embodiment, the backrest 3 of the motor vehicle seat 1 is also adjusted by the method according to the invention. The method detects the manual adjustment of the backrest 3 by a user. Such an adjustment of the backrest 3 can take place, for example, when a user wants to get out of the vehicle from a row of seats arranged behind the motor vehicle seat 1 and unconsciously holds or supports himself on the backrest 3. An adjustment movement of the backrest 3 is not desired in this case and may even lead to the risk of injury to the user. The sensor 9 detects in method 200 this manual adjustment of the backrest 3 and, in the next method step 300, generates a sensor signal proportional to the manual adjustment. A control algorithm determines in method step 400 the direction and the strength of the manual force F exerted on the backrest 3.

The voltage signal generated thereupon in method step 500 uses a pulse-width-modulated voltage and causes the adjustment motor 8 to perform a rotary movement (method step 600). This rotary movement counteracts (method step 700) the manual adjustment of the backrest 3 carried out by the user. The driving force of the adjustment motor 8 is calculated by the control algorithm in such a way that the desired position (easy-entry position) of the backrest 3 is maintained. The manual adjustment movement of the user is counteracted in such a way that the adjustment of the backrest 3 is carried out by only a few angular degrees. A manual adjustment by less than 1° is preferred.

Due to this embodiment of the invention, the adjustment motor 8 has a self-locking mechanism in one direction. The backrest 3 cannot be adjusted in the actuating direction even in the case of an increased application of force. However, it is also conceivable that the self-locking mechanism is designed in such a way that an increased application of force in the actuating direction allows for an adjustment of the backrest 3.

The motor vehicle seat 1 according to the invention therefore does not require any additional components such as brakes or latching mechanisms, the installation of which is associated with higher costs and increased space requirements. In the event of a malfunction of the electrical supply to the motor vehicle seat 1, for example in the event of a voltage drop due to a discharged battery, a user can adjust the backrest 3 of the motor vehicle seat 1 manually at any time based on this embodiment of the invention.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A method for adjusting a seat component of a motor vehicle seat, said method comprising:
detecting a manual adjustment of a seat component; and
generating a force by activating a motor to adjust the seat component in response to the manual adjustment.

2. The method of claim 1, wherein the manual adjustment is detected by a sensor, and further comprising generating by the sensor a sensor signal in response to the manual adjustment.

3. The method of claim 1, further comprising executing a control algorithm after detecting the manual adjustment of the seat component.

4. The method of claim 1, further comprising generating a voltage signal to cause a rotary movement of the motor after detecting the manual adjustment of the seat component.

5. The method of claim 4, wherein the voltage signal is proportional to a speed of the manual adjustment.

6. The method of claim 1, wherein the force generated by the motor counteracts a movement of the manual adjustment.

7. The method of claim 1, wherein the manual adjustment is detected by a memorization sensor system and/or by a sensor for detecting an actuation of a control element and/or an unlocking means and/or by means of a sensor for detecting an adjustment path.

8. A motor vehicle seat, comprising:
a seat component; and
a motorized adjustment device for adjusting seat component, said the motorized adjustment device including a self-locking mechanism configured such that the self-locking mechanism in a first direction of movement of the adjustment device is unequal to the self-locking mechanism in a second direction of movement of the adjustment device.

9. The motor vehicle seat of claim 8, wherein the adjustment device includes a non-self-locking gear motor.

10. The motor vehicle seat of claim 8, wherein the adjustment device includes a reversible gear motor.

11. The motor vehicle seat of claim 8, wherein the adjustment device includes a self-locking mechanism counter to the direction of movement of the manual adjustment.
